(19) United States
(12) Patent Application Publication
(10) Pub. No.: US 2012/0307490 A1
(43) Pub. Date: Dec. 6, 2012

(54) Illuminated mirror design and method

(75) Inventor: Mary L. Ellis, Chapel Hill, NC (US)

(73) Assignee: Elavue, Inc.

(21) Appl. No.: 13/134,229

(22) Filed: May 30, 2011

(51) Int. Cl. F21V 11/00; F21V 29/00

(52) U.S. Cl. 362/235

(57) ABSTRACT

An illumination system including an elongate rectangular mirror; a first diffuser mounted on a first side of said mirror in parallel relation along an longitudinal axis thereof; a second diffuser mounted on a second side of said mirror in parallel relation along said longitudinal axis; and an array of light emitting diodes mounted along an edge of said first and said second diffusers. The light emitting diodes are mounted on a heat sink disposed on a backplane behind the mirror and the diffusers. Arrangements are provided for adjusting the color temperature and intensity of the system and for sensing motion and activating the system in response thereto.

### BACKGROUND OF THE INVENTION

1. Field of the Invention

The present invention relates to lighting systems. More specifically, the present invention relates to illuminated mirrors.

2. Description of the Related Art

Due to the typical lighting arrangement, customers in a retail dressing room are all too often unhappy with the way they see themselves in the mirror while trying on clothes. (See Effects of Dressing Room Lighting Direction on Consumers' Perception of Self and Environment, Baumstarck, A., Park, N-K; University of Florida, 2009.) The perception is usually that the conditions in the room highlight, accentuate, and/or create under-eye bags, uneven skin tone and texture, wrinkles, less-than-desirable body fat distribution, cellulite, bulging veins, odd skin color, etc.

There are many blog and forum entries as well as articles on the subject on the Internet in which most women—and a surprising number of men—express agreement. For these people, the dressing room experience is often painful and seldom pleasant, and indeed affects their purchasing decisions. As a result, customers often choose: 1) to buy only what they perceive as absolutely necessary; 2) to take clothes home to try on in more pleasing conditions and then return what doesn't work; 3) to forego the entire experience and make their purchases on-line; or 4) all too often to buy nothing out of frustration and disappointment. Hence, in the apparel business it is often said that “the sale is made in the dressing room.”

The problem is primarily an issue of lighting, with most dressing rooms being lit by overhead sources—usually fluorescent or halogen bulbs—that are often very harsh and/or color-distorted. Such lighting casts hard shadows, often at unflattering color temperatures, which are responsible for most of the unpleasant effects. But remarkably little has ever been done to optimize lighting conditions in retail dressing rooms in order to affect—i.e., increase—sales.

Conventional solutions include the use of fluorescent or incandescent sconces placed alongside the mirror. However, this approach offers little improvement inasmuch as the sconces typically don't give off enough light.

A few years ago, dressing room atmospherics as a factor in sales came on the radar in the apparel industry and consequently the retail design community. As a result, poor dressing room conditions have been cosmetically improved fairly recently: Some rooms have been cleaned up, painted, provided with more hooks, and new carpeting.

Higher-end shops made their dressing rooms a luxury haven, bringing in over-sized gilt-frame mirrors and poufy furnishings. Some tried to deal with the lighting—usually by simply dimming and/or warming it to the point where it was difficult to see, i.e., near-candlelight.

Some stores, including a few chains, have employed side-lit mirrors, utilizing either fluorescent or incandescent lighting. Such side-lit mirrors are bulky and often unattractive, and require a high level of maintenance inasmuch as the bulbs burn out quickly. Also, these conventional systems generate substantial heat, which may affect a building's HVAC systems, and may present a potential burn risk for customers if not shielded properly. Other hazards include the possibility of broken or shattered glass, and the toxic release of mercury from broken fluorescent bulbs. Additionally, these conventional systems are generally part of the architecture of the space, and must be designed into the room; i.e., they cannot be dropped into any existing space.

Accordingly, a need remains in the art for an improved system or method for providing illumination for use with mirrors in retail dressing rooms.

### SUMMARY OF THE INVENTION

The need in the art is addressed by the illumination system of the present invention which, in an illustrative embodiment, includes an elongate rectangular mirror; a first diffuser mounted on a first side of said mirror in parallel relation along a longitudinal axis thereof; a second diffuser mounted on a second side of said mirror in parallel relation along said longitudinal axis; and an array of light emitting diodes mounted along an edge of said first and said second diffusers.

In a specific embodiment, the light emitting diodes are mounted on a heat sink disposed behind the mirror and the diffusers. The LED chips are mounted into a Printed Circuit Board (PCB). The PCBs are mounted in the aluminum frame, which serves as a heat sink.

An arrangement is provided for adjusting the color temperature and intensity of the system. In addition, an arrangement is taught for sensing motion and activating the system in response thereto.

### BRIEF DESCRIPTION OF THE DRAWINGS

FIG. 1 is a frontal view of an illustrative embodiment of a lighted mirror implemented in accordance with the teachings of the present invention.

FIG. 2 is a simplified schematic perspective view of the lighted mirror of FIG. 1.

FIG. 3 is a sectional side view of the lighted mirror of FIG. 1.

FIG. 4 is a block diagram of an illustrative embodiment of a circuit for use with the lighted mirror of FIG. 1 in accordance with the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

The present invention is a lighted mirror design and method. The inventive mirror provides a means for optimizing lighting and viewing conditions in the dressing room, where the sale is often ultimately made, thereby improving customer experience in a store and increasing clothing sales.

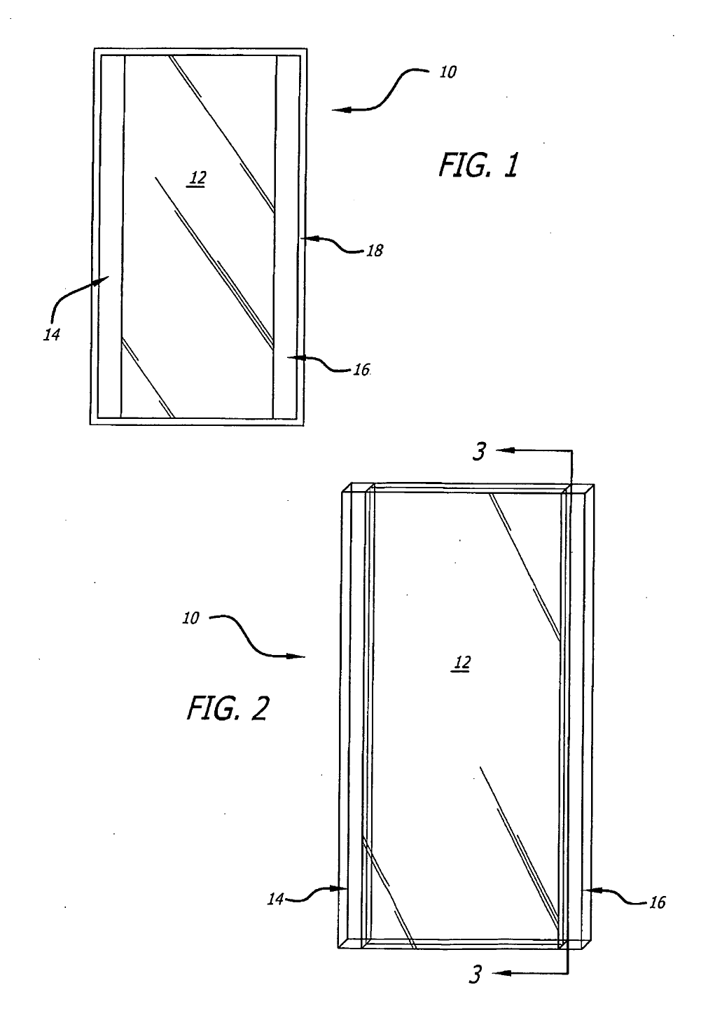

FIG. 1 is a frontal view of an illustrative embodiment of a modular integrated lighted mirror implemented in accordance with the teachings of the present invention. The system 10 includes a mirror 12 fabricated of glass, metal, Plexiglas or other suitably reflective surface. In the best mode, the mirrors are fabricated of standard high-quality (e.g. ¼ inch) distortion-free glass. The mirror 12 is planar and has a longitudinal axis not shown along the length thereof. In the illustrative embodiment, the mirror is 24 inches by 72 inches. However, the present teachings are not limited to the size or shape of the mirror. The mirror is sandwiched between two illumination elements 14 and 16 and is disposed within an optional decorative frame 18.

The illumination elements 14 and 16 are light diffusers that distribute light from light emitting diodes (LEDs). The mirror could have nonreflective clear or frosted side panels behind which the diffusers are mounted.

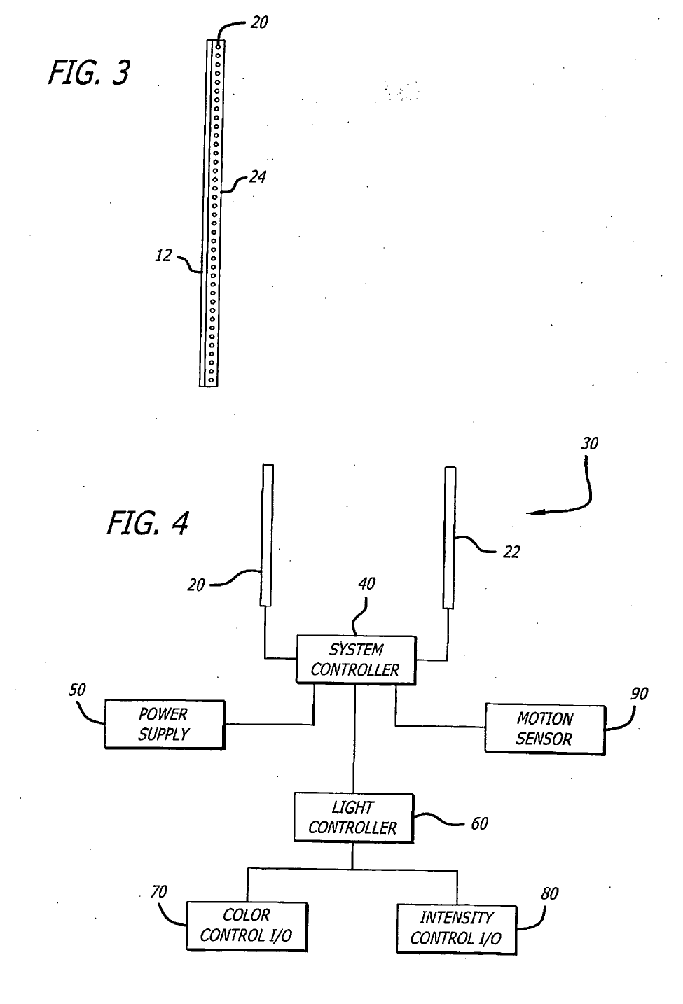

The arrangement of LEDs is illustrated more clearly with reference to FIGS. 2 and 3. FIG. 2 is a simplified schematic perspective view of the lighted mirror of FIG. 1. FIG. 3 is a sectional side view of the lighted mirror of FIG. 1 along the line 3-3 of FIG. 2. As shown in FIG. 3, on each side of the mirror 12, an array of LEDs 20 aligned in rectilinear relation along the longitudinal axis of the mirror 12. Preferably, the LEDs are purchased from GO Lighting Technologies or another suitable manufacturer given that GO Lighting makes and sells tunable flat panel LED fixtures (see GOs FLL Planar R-Series Flat Panel luminaire at http://www.goenergyeffective.com/) that are well-suited for the inventive application.

In the best mode, the lights are tunable as discussed more fully below. The tunability feature will allow the light output to be customized specifically for the space the unit will be used in. For example, an extremely small dressing room painted a very light color will require one setting (CCT/Lumens), while a much larger room painted a darker color will require a different setting for best atmospherics and effect. A high Color Rendering Index (CRI) and calibrated intensity of lighting allow viewers to clearly see and accurately evaluate and compare colors and fabric textures. In accordance with the present teachings, the color temperature and intensity are either preset in the factory or controlled by the user using an input/output interface as illustrated in FIG. 4.

An illuminated mirror implemented in accordance with the present teachings may be adapted to accept a standard frame of the customer's choosing.

Plural rows or arrays of LEDs may be used without departing from the scope of the present teachings. In the illustrative embodiment, the LEDs have a color rendering index (CRI)@3000° K=>90. The LEDs should have a color controlled temperature (CCT) range between 2700 degrees Kelvin and 3500 degrees Kelvin.

However, the present invention is not limited to the type of LEDs employed. Although one row of LEDs is depicted in the drawing, two or more rows of LEDs may be included in each array on each side of the mirror without departing from the scope of the present teachings.

The diffusers 14 and 16 provide illumination surfaces for light distribution and diffusion. The diffusers serve to ensure that light output by the LEDs is evenly and uniformly distributed with no bright or dim areas. In the best mode, the diffuser is a three or four layer composition fabricated of polycarbonate and layers of specialty light dispersion materials and is of a shatterproof construction that remains cool to the touch, even at max output for an extended period of time.

The LED elements are mounted on a printed circuit board (not shown) on a metal frame 24. In practice, as LED chip technology evolves, one would select the number, type and size of LEDs to achieve optimal lighting for the intended environment.

In the illustrative embodiment, the output of light into the intended environment can best be measured in foot-candles (fc). At a distance of 4 feet from the center midline of the unit, the light output may vary from an optimal range of 20 fc to 50 fc, as appropriate for the lighting effect desired assuming a user will be standing anywhere from a minimum of two (2) ft to a maximum of approximately seven (7) ft from the unit, totally depending on the size of the space. This relates to tunability. One of ordinary skill in the art can determine the best setting based on the requirements of a given application.

In the best mode, the metal frame 24 is fabricated of aluminum and serves as a heat sink for the LEDs. The heat sink is extruded, anodized aluminum or other suitable heat sink material.

FIG. 4 is a simplified block diagram of an electrical power and electronic control system 30 for use with the illuminated mirror system of the present invention. The electrical system 30 includes a system controller 40 which switches and routes power from a power supply 50 to first and second LED arrays 20 and 22 disposed on first and second respective sides of the mirror 12 of FIG. 1. In accordance with the preferred embodiment of the present teachings, the color temperature and the intensity of the light output by the LEDs is controlled by a light controller 60 in response to user input received via a color temperature control user interface 70 and an intensity control user interface 80. This functionality is implemented in the LED array in the PCBs, consisting of both warm-colored chips and cool-colored chips. The user-interface allows user to “mix” the light between the warm/cool chips to achieve the desired color temperature. The user interface can be a hand-held remote control device, a dial mounted on the wall, a wall-mounted set of buttons, something mounted on the unit itself, etc.

The light controller may be implemented as part of the system controller. As an alternative, the light controller may be implemented in software stored on a tangible medium, such as a programmable read only memory, RAM or other suitable storage device, executed by a microprocessor disposed within the light controller 60.

An optional motion sensor 90 may be included to activate and deactivate the LEDs in response to a detected presence of a user to conserve energy and extend LED life. The motion detection sensor or “EYE” can be mounted in unit itself or remotely wired and mounted in the room (ceiling, hidden, etc.). Motion sensors are well known in the art (see http://en.wikipedia.org/wiki/Motion_sensor) and may be purchased from such vendors as Visonic, Sensaphone and Uptime Devices to name a few. With motion detection, the illuminated mirror would be in a standby state at which the LEDs would remain on at low power level (i.e., 10% of max). When a customer enters the dressing room, the lights come up immediately to full power and then return to standby when the room is vacated. After business hours when the store is closed, the LEDs are completely turned off. With motion detection, the life of the lights can be effectively extended.

Thus, an illuminated (ELAVUE) mirror has been disclosed. The ELAVUE mirror is a modular integrated mirror and lighting unit or appliance that enhances customers' perceptions of themselves in (and out of) the clothes they are considering, resulting in longer stays, more clothing fittings, a more enjoyable shopping experience, and, ultimately, more sales.

The present invention has been described herein with reference to a particular embodiment for a particular application. Those having ordinary skill in the art and access to the present teachings will recognize additional modifications, applications and embodiments within the scope thereof. For example, a three-paneled mirror system incorporating an LED lighting array as described herein may be constructed utilizing the present teachings, allowing customers to view themselves from multiple angles (side, back, etc.) simultaneously in preferred lighting conditions. Additionally, an LED lighting array with specifications described herein may be installed and utilized without the integrated mirror component, allowing such an array to be placed adjacent to the sides of an existing mirror which may already be in place in the environment. Further, the inventive mirror design and the present teachings may be utilized in areas other than dressing rooms such as hotels, homes, cruise ships, spas, gyms, etc.

It is therefore intended by the appended claims to cover any and all such applications, modifications and embodiments within the scope of the present invention. Accordingly,

What is claimed is:

1. A system comprising:
a reflective surface and
at least one light source disposed in close proximity to said surface, said light source including:
a array of light emitting diodes and
a diffuser in optical alignment with said diodes.

2. The invention of claim 1 wherein said reflective surface is a mirror.

3. The invention of claim 2 wherein said mirror is glass.

4. The invention of claim 2 wherein said light emitting diodes are mounted along an edge of said diffuser between said diffuser and said mirror.

5. The invention of claim 4 wherein said light emitting diodes are mounted on a heat sink.

6. The invention of claim 5 wherein said heat sink is disposed behind said mirror.

7. The invention of claim 6 wherein said heat sink is disposed behind said diffuser.

8. The invention of claim 7 wherein said heat sink is aluminum.

9. The invention of claim 1 further including means for adjusting the color temperature of said system.

10. The invention of claim 1 further including means for controlling the intensity of said system.

11. The invention of claim 10 further including means for sensing motion and activating said system in response thereto.

12. A system comprising:
an elongate rectangular mirror,
a first diffuser mounted on a first side of said mirror in parallel relation along a longitudinal axis thereof;
a second diffuser mounted on a second side of said mirror in parallel relation along said longitudinal axis; and
an array of light emitting diodes mounted along an edge of said first and said second diffusers.

13. The invention of claim 12 wherein said light emitting diodes are mounted on a heat sink.

14. The invention of claim 13 wherein said heat sink is disposed behind said mirror.

15. The invention of claim 14 wherein said heat sink is disposed behind said diffusers.

16. The invention of claim 15 wherein said heat sink is aluminum.

17. The invention of claim 12 further including means for adjusting the color temperature of said system.

18. The invention of claim 12 further including means for controlling the intensity of said system.

19. The invention of claim 18 further including means for sensing motion and activating said system in response thereto.

20. A method of illuminating an environment including the steps of:
providing an elongate rectangular mirror,
mounting a first diffuser on a first side of said mirror in parallel relation along a longitudinal axis thereof;
mounting a second diffuser on a second side of said mirror in parallel relation along said longitudinal axis; and
mounting an array of light emitting diodes along an edge of said first and said second diffusers.
